(19) United States
(12) Patent Application Publication
(10) Pub. No.: US 2006/0215074 A1
(43) Pub. Date: Sep. 28, 2006

(54) Collimated scanning backlight device

(76) Inventors: Martin Jacobus Johan Jak, EINDHOVEN (NL); Hugo Johan Cornelissen, Eindhoven (NL); Hendrik De Koning, Eindhoven (NL); Dirk Jan Broer, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/547,950

(22) PCT Filed: Feb. 26, 2004
(86) PCT No.: PCT/IB04/50153

§ 371 Date: Sep. 6, 2005

(30) Foreign Application Priority Data
Mar. 6, 2003 (EP) 03100556.4

(51) Int. Cl. G02F 1/1335

(52) U.S. Cl. 349/65

(57) ABSTRACT

The invention relates to a scanning backlight device, based on dynamic light extraction, the device comprising a light guide structure (24), a light source for emitting light, arranged to be directed into said light guide structure, the light guide structure (24) being provided with an addressable out-coupling member, comprising two or more defined areas, each providing switchable out-coupling of light from said light guide structure (24). The scanning backlight device is characterised in that at least one micro-optical redirection member (23), arranged in proximity with said light guide structure (24), being arranged to redirect light emitted from said light guide structure (23) in an essentially normal direction of said light guide structure.

This invention relates to a scanning backlight device, based on dynamic light extraction, the device comprising a light guide structure, a light source for emitting light, arranged to be directed into said light guide structure, the light guide structure being provided with an addressable out-coupling member, comprising two or more defined areas, each providing switchable out-coupling of light from said light guide structure.

Displays utilising light valve or shutter technology are today commonly used. A typical example of such a display is a liquid crystal display, often driven by means of active matrix driving. The basic function of light valve or shutter displays is that the display, or a pixel pattern thereof, may either transmit light (white pixel) or block light (black pixel), but the display may not generate light itself. Therefore, an illuminating backlight is needed.

When a display, such as an active matrix liquid crystal display, is to display video material, such as moving television pictures, the panel often exhibit motion blur. Since the use of liquid crystal displays is becoming more common in the field of television, the quality of moving pictures is becoming increasingly important. It has however been shown that the use of a so-called scanning backlight, essentially overcomes the above problem. A standard scanning backlight comprises a plurality of lamps, being arranged in a panel-like fashion, and scanning of the backlight is performed by switching lamps on an of in a correct order. This implies that at a certain moment in time, only a fraction of the lamps is actually on, and thus more lamps are needed in order to compensate for this.

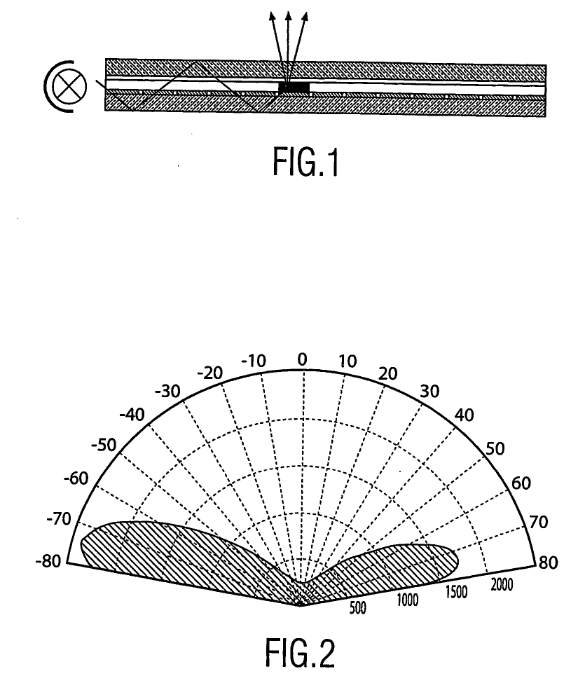

A more efficient scanning backlight may be realised by using a light guide structure, into which lamps constantly emit light. The light may thereafter be dynamically extracted from the light guide. An example of such a scanning backlight for dynamic light extraction is disclosed in the patent document WO 02/21042. This document describes an illuminating backlight based on the scanning window principle, comprising a light guide and light sources, being arranged to introduce light into a side of the light guide. The switching function may be obtained by a layer of scattering liquid crystal material (also referred to as an LC-gel, which is obtained by photo-polymerisation of a blend of a liquid crystalline monomer and a (or a mixture of) non-reactive liquid crystals in the presence of a photo-initiator), that may be switched between a transparent and a scattering state. Such a scanning backlight is schematically shown in FIG. 1.

However, in practice, the scattering properties of the LC-gel are such that a large amount of light is emitted at grazing angles. An example of the angular light distribution from a dynamic scattering light guide is disclosed in FIG. 2. Since a display device rarely is viewed at these grazing angles, this is undesirable. Some efforts to redistribute the emitted light towards the normal direction of the display have therefore been made. For example, brightness enhancement foils, for example manufactured by 3M, have been developed. However, such foils are expensive, and only a limited amount of brightness gain may be achieved along the normal. Alternative solutions to this problem is therefore desired.

Hence, an object of this invention is to overcome the problems with the prior art as indicated above. Further, an object of this invention is to improve the brightness of a backlight in the normal viewing direction. Yet an object of this invention is to provide a comparatively cost-efficient solution to the above-mentioned problems.

The above and other objects are at least in part achieved by a scanning backlight device as defined by claim 1. This scanning backlight device, which is based on dynamic light extraction, comprises a light guide structure, having opposing forward and rearward faces, a light source for emitting light, arranged to be directed into said light guide structure, the light guide structure being provided with an addressable out-coupling member, comprising two or more defined areas, each providing switchable outcoupling of light from said light guide structure, characterised in that at least one micro-optical redirection member is arranged in proximity with said light guide structure, being arranged to redirect light emitted from said light guide structure in an essentially normal direction of said light guide structure. With such a micro-optical redirection member, the angular distribution of the emitted light from the scanning backlight may be modified. Light emitted at grazing angles is redirected towards the normal viewing direction, which results in an enhanced brightness in this viewing direction.

According to a first embodiment of this invention, said micro-optical redirection member is arranged as a layer arranged on a forward side of the light guide structure, one surface of the layer being provided with a transmissive prismatic structure. Thereby, by suitably choosing the material and top angles of the prismatic structure, a suitable transmissive redirection member may be generated. Suitably, the prismatic structure is arranged on the side of the micro-optical redirection member facing the light guide structure. Also, the top angle of the prismatic structure essentially falls within the interval 40-80°, preferably within 50-70° and most preferably is about 60°.

As an alternative embodiment, the prismatic structure may comprises alternating prismatic protrusions and flat areas. This further improved the efficiency of the backlight, especially for backlights generating light within a broad angle distribution. According to yet an embodiment, said micro-optical redirection member is suitably arranged as a layer arranged on a rearward side of the light guide structure, one surface of the layer being provided with a reflective prismatic structure. This embodiment is advantageous in that no additional components need to be added to the device. Suitably, the prismatic structure is arranged on the side of the micro-optical redirection member facing the light guide structure. Also, the top angle of the prismatic structure essentially falls within the interval 70-110°, preferably within 80-100° and most preferably is about 90°.

The invention will hereinafter be described in closer detail, by means of presently preferred embodiments thereof, with reference to the accompanying drawings.

FIG. 1 is a schematic cross section of a scanning backlight for dynamic light extraction according to the prior art.

FIG. 2 is a plot of the angular distribution of light emitted be a dynamic scattering light guide in a backlight as disclosed in FIG. 1.

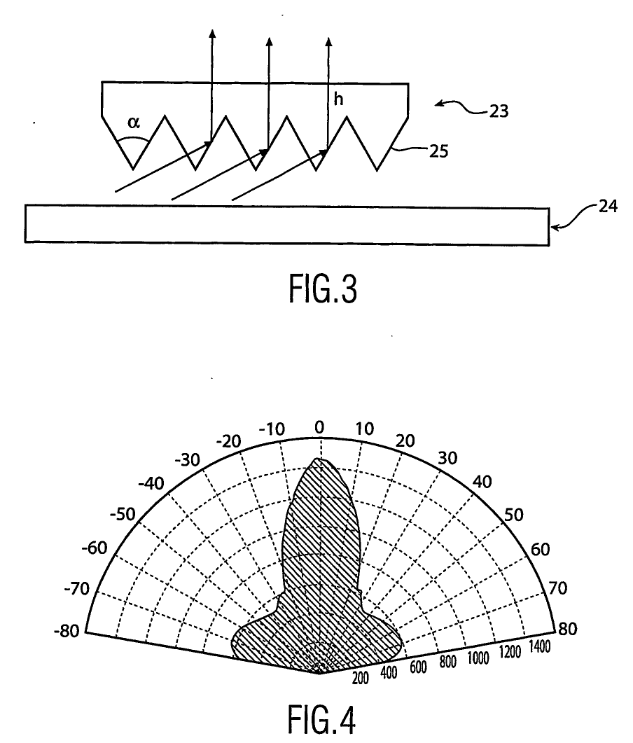

FIG. 3 is a schematic cross section drawing disclosing the main principle of a first embodiment of this invention.

FIG. 4 is a plot of the angular distribution of light emitted be a dynamic scattering light guide in a backlight as disclosed in FIG. 3.

FIG. 5 is a schematic cross section drawing disclosing a second embodiment of this invention.

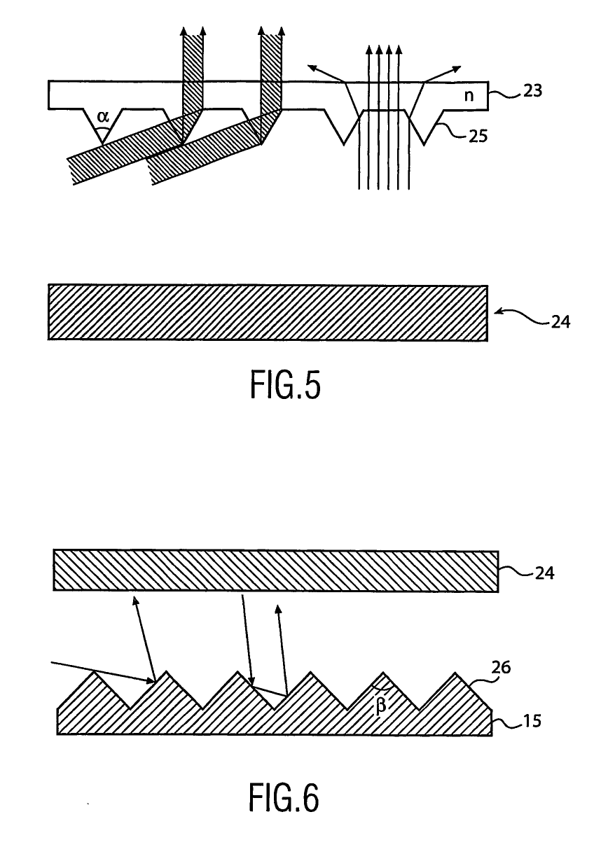

FIG. 6 is a schematic cross section drawing disclosing a third embodiment of this invention.

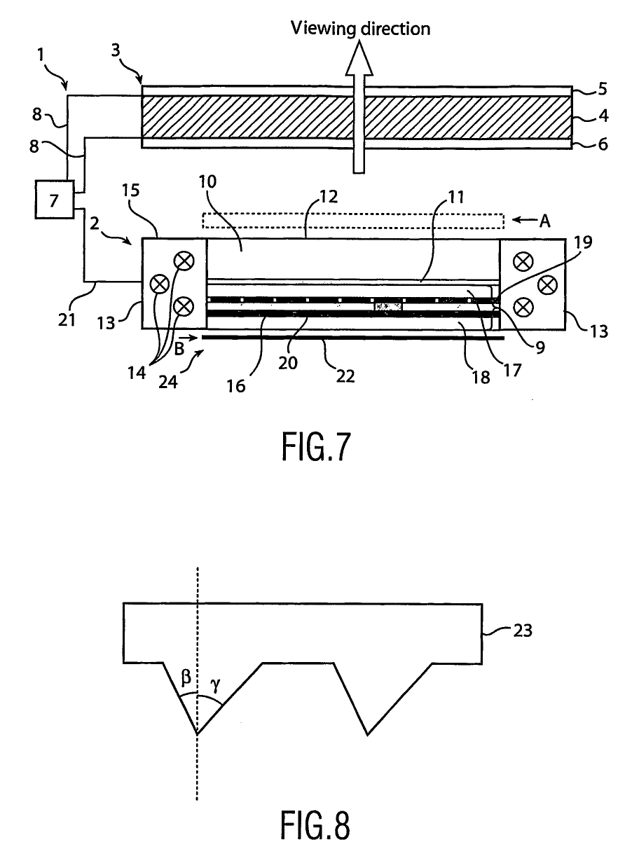

FIG. 7 is a schematic cross section view of a scanning backlight in which the present invention is to be incorporated.

FIG. 8 is a schematic cross section view of a detail of yet an embodiment.

This invention is concerned with a scanning backlight system, for use for example with a display panel for generating a display device. A schematic drawing of a display device 1, comprising a scanning backlight 2 in which the invention may be implemented is disclosed in FIG. 7. The entire backlight 2 is arranged to be positioned behind the display panel 3.

The display panel 3 essentially comprises a layer 4 of an electro-optical material, such as a liquid crystal material, based on for example twisted nematic, optically compensated birefringence, in-plane switching, super-twisted nematic or ferro-electric operation, in order to provide a light valve function, for modulating light incident on the display panel. The layer 4 is essentially sandwiched between a first and a second substrate 5, 6. Moreover, the display panel 3 is suitably subdivided into a matrix of pixels being controlled by electrode means (not shown) arranged on said substrates 5, 6. Preferably, active matrix addressing is used. The electrode means are provided with control voltage signals from a drive unit 7, via connection wires 8. Further, on per se known manner, the display panel is further provided with a polariser and an analyser, and the substrates and the electrodes are manufactured form a light-transmissive material.

The backlight 2 to which this invention primarily relates essentially comprises a first and a second light guide structure 9, 10. The first light guide structure 9 comprises a layer of a scattering liquid crystal material and will be closer described below. The stabilizing second light guide structure 10 essentially consists of a light guiding material, and in this embodiment, the first and second light guide structure 9, 10 are adhered together by means of an adhesion layer 11 (such as a glue layer) in order to together form a backlight light guide structure 24. However, it shall be noted that said second light guide structure 10 may be excluded from the inventive backlight, and in such cases the backlight light guide structure is essentially constituted by the first light guide structure 9 on its own. The backlight light structure 24 has an exit face 12, being arranged to face said display panel 3, and suitably four end faces 13. A light source 14, such as for example a rod shaped fluorescence lamp is arranged along at least one of said end faces 13 (in the case displayed in FIG. 7 along two end faces) and light emitted by said light source 14 is arranged to be coupled into the backlight light guide structure 24 through said end face 13. Suitably, a reflection device 15 is arranged around said light source 14 in order to redirect light emitted by the light source into the backlight light guide structure 24. The first light guide structure 9 essentially comprises a layer 16 of a scattering liquid crystal gel material, being sandwiched between a first substrate 17 and a second substrate 18. The substrates are manufactured from an essentially light-transparent material, such as glass. Moreover, the light guide is subdivided into a pattern by means of a plurality of patterned front and back electrodes 19, 20, arranged on said first substrate 17 and said second substrate 18, respectively. The electrodes 19, 20 are connected to the drive unit 7 by means of connection wires (schematically indicated by 21). By addressing the electrodes 19,20 different areas of the scattering liquid crystal gel material layer 16 may be switched between a transmissive state, in which the area only transmits light which is later internally reflected within the backlight light guide, and a scattering state, in which light is scattered by the pixel and hence allowed to be transmitted through the exit face 12 of the light guide, in direction towards the display panel 3. Furthermore, a reflector 22 may be provided on a back side of the backlight light guide, opposite the exit face 15, in order to reflect light back into the light guide to improve the efficiency of the light guide. In fact, all surfaces of the light guide structure 24, except the incoupling end face or end faces 13 and the exit face 12, may be provided with a reflective coating or the like, in order to prevent light from exiting the light guide 24 at undesired positions.

This invention is based on the realisation that the light emitted by the scanning backlight 2 through the exit face 12 may be redirected in an essentially forward direction, i.e. in a direction essentially normal to the backlight 3 and/or the display panel 4, in order to improve the brightness in the normal viewing direction of the display.

According to a first embodiment of this invention, this may be achieved by including a micro-optical redirection member, such as a redirection foil between the display panel 3 and the scanning backlight 2, i.e. in the position A indicated in FIG. 7. According to this first embodiment, the micro-optical redirection member 23 has a design schematically disclosed in FIG. 3. In this embodiment, the redirection member 23 is constituted by a redirection foil, provided with an essentially continuous prismatic structure on the side of the foil facing the scanning backlight 2, i.e. a plurality of prismatic protrusions 25 arranged side by side and essentially covering the entire surface of the redirection member 23. The prismatic structure may be in one dimension (i.e. a groove-like pattern) if the light source is arranged as lamps on two opposite sides of the display device, or in two dimensions (i.e. a pyramid-like pattern) if the light source is arranged as lamps on all sides of the display device. In the present case, the top angle α of each prism 25 of the prismatic structure is essentially 60°, and the resulting angular distribution of the light emitted by a backlight provided with the above described micro-optical redirection member is disclosed in FIG. 4. As compared to the angular distribution plot disclosed in FIG. 2, it may be noted that thanks to the inventive redirection member, the light output is collimated in the normal direction, and hence a viewer of the display device will experience a larger brightness. This is because the prismatic structure disclosed in FIG. 3 will redirect light emitted by the scanning backlight 2 at grazing angles towards the normal. The exact efficiency of the structure is due to angular distribution of light from the scanning backlight 3, as well as the top angle α and the refraction index n of the redirection member in order to achieve internal reflection and redirection of the light falling into the redirection member 23. Hence, the top angle of the prismatic structure may be optimised for a chosen configuration, and may for instance lie within the interval 40-80°, preferably within the interval 50-70°, and most preferably about 60° for standard configurations of the scanning backlight 2. Moreover, the exact efficiency depends on the scattering power of the liquid crystal gel material layer 16 of the scanning backlight 2. If the layer 16 is biased with a relatively low bias voltage, scattering is mainly in the forward direction, and the redirection structure functions very well. At higher bias voltages, the scattering of the layer 16 becomes more isotropic, and the collimation of the redirection member 23 becomes less efficient, but still a brightness gain is achieved.

A second embodiment of this invention is disclosed in FIG. 5. This embodiment is essentially similar to the one disclosed in FIG. 3, but differs from it in that the prismatic structure is discontinuous, i.e. a spacing or flat surface portion is arranged between essentially each prismatic protrusion. By separating the protrusions in the redirection member 23, this member becomes more transparent for rays already having a direction close to the normal of the display device, whereas the effect on grazing rays hardly changes, as compared to the first embodiment. Hence, the redirection member 23 becomes more efficient in cases when the scanning backlight 2 provides a broader angle distribution of light. In this case, rays that are emitted at grazing angles from the backlight 2 hardly notice any difference as compared to the embodiment disclosed in FIG. 3, due to shadowing, which phenomenon is illustrated by FIG. 5. However, rays that are emitted essentially along the normal direction of the backlight 2 have a larger probability of being transmitted through the redirection member 23, without changing direction, which is also indicated by FIG. 5. The distance between the protrusions of the prismatic structure may be selected depending on the angle distribution of the grazing rays, so that the above shadow effect may be utilized in an optimal way and depending on the amount of essentially normal rays. Moreover, the top angle of each protrusion follows the same reasoning as for the example disclosed in FIG. 3 and described above.

A third embodiment of this invention will hereinafter be closer described with reference to FIG. 6. According to this embodiment of this invention, the inventive objects may be achieved by including a micro-optical redirection member 23 behind the scanning backlight 2, i.e. in the position B indicated in FIG. 7. As is indicated above, the backlight light guide emits light both towards the front and the back side of the light guide, and hence, the micro-optical redirection member may equally well be positioned behind the scanning backlight 2, as seen by a potential viewer of the display device 1. Hence, the reflector 22, disclosed in FIG. 7 may be modified and structured in order to collimate reflected output light along the normal direction. For this purpose, the reflector comprises a pattern of grooves or prismatic protrusions 26, much like the protrusions of the redirection member of FIG. 3. However, in this case the top angle β of the protrusions is preferably about 90′ in order to reflect rays incident along the normal essentially in the direction from which they came, whereas at the same time reflect rays at gracing angles towards the normal as well. Hence, the light reflected off the redirection member, in this case formed by the reflector 15, will be collimated along the normal.

For all embodiments described above, multiple lamps, such as for example cold cathode fluorescent lamps (CCFL) may be needed in order to obtain a sufficient light output from the backlight 2. For instance, in the embodiment disclosed in FIG. 7, lamps are provided along two sides of the display device 1, for example along the top and bottom side of the display device. Moreover, as indicated above, a reflection device 15 is arranged to surround each set of lamps in order to couple as much light as possible into the light guide. Further, the dimensions of the lamps put restrictions on the thickness of the light guide. In some cases, the backlight light guide needs to be thicker or much thicker than the first light guide structure 9, containing the liquid crystal gel layer 16, and therefore it may be adhered or glued to a second light guide structure 10, for example constituted by a thick polymer sheet. On the backside of the light guide 24, a reflector 22 is positioned as indicated above, and the reflector may be structured, as in the third embodiment described above, or un-structured. Moreover, the additional second light guide structure 10 is preferably placed in front of the first light guide structure, as seen by a potential viewer, and hence, the light guide containing the LC-gel is positioned closer to the reflector 22. This is advantageous in that parallax may be avoided. However, if parallax is no issue, then the light guide containing the LC-gel may be positioned on a front side of the additional second light guide structure, as seen by a potential viewer. It shall also be noted that in the embodiments including an additional second light guide structure, this light guide may be used as a main light guide, being arranged to guide most of the light emitted by the light source.

Moreover, as indicated above, more lamps may be needed, and for instance lamps may be positioned along all four sides of a light guide. However, in this case, redirection may be necessary in two dimensions. This may be realised by providing a two-dimensional redirection pattern on the micro-optical redirection member, or alternatively use two orthogonally crossed one-dimensional redirection members (only embodiment 1 and 2 above) placed on top of each other.

However, the present invention may also be utilised with a single lamp or light source, or in cases in which light is emitted through only one single side of the light guide. In those cases, the redirection means 23, having a prismatic structure 25, need not have a symmetric cross-section as the one disclosed in FIG. 3. Instead, the redirecting micro-prisms may have two facets, an input facet and a reflection facet, not necessarily having identical angles with the surface normal, in order to optimise the performance of the redirection means in relation to the position of the light source. An example of such a redirection means is disclosed in FIG. 8, in which β≠γ.

A further advantageous alteration of this invention will hereinafter be described. The aim of this alteration is to further improve the contrast of the display, by making bright parts of the display brighter, and dark parts of the display darker. Moreover, the colour range and the efficiency of the backlight may be improved. This may be realised by a light source modulator being arranged to modulate the power fed to the light source 14 of the scanning backlight 2 system synchronised with the scrolling scattering addressing of the scanning backlight 2. Thereby, if a presently addressed part is arranged to supply light to a part of the display device that is to be bright at the moment, the power to the light source may be increased, and hence the light source emits more light, and if a presently addressed part is arranged to supply light to a part of the display device that is to be dark at the moment, the power to the light source may be decreased, and hence the light source emits less light. In this way the bright parts of the backlight may be made brighter and the dark parts darker. Since the light is more efficiently transported to the place where it is needed this will result in more efficient backlighting and a brighter sparkling image. By applying the same technique separately for different colours, such as red, green and blue light sources, the colour of the backlight may be varied over the screen. Effectively this results in a larger range of usable colours.

In order to be sufficiently accurate it may be desired to include a feedback loop comprising one or more light sensors (not shown) that measures the actual lamp output and compares this with the required output for the image part that is to be displayed. The detected signal of the light sensor (not shown) is arranged to be fed back to a lamp driver (not shown), the lamp driver also being connected to receive information from the drive unit 7. Thereby, the illumination power fed to each area of the scanning backlight may be varied in response to the image content to be display by a corresponding pixel or number of pixels of the display panel 3. Hence, by varying the light source power while the segmented backlight is being addressed, the contrast of the display may be improved. When a segment i is being addressed (i.e. it is scattering) the power source will have power pi, and when a segment j is scattering the source will have power pj. The power pi is adjusted depending on the required brightness for segment i and the average power of the lamp of the backlight 3 should be constant. Preferably, the light sources of the backlight is constituted by light emitting devices (LEDs) and such devices may be varied in power relatively easily in an efficient way. Moreover, LEDs may be switched very fast and are limited by the average power, and hence short pulses may be made very bright. Alternatively, the light sources of the backlight may be constituted by cold cathode fluorescent lamps (CCFL) having different phosphors or phosphor mixes.

Moreover, the use of LEDs are advantageous in that LEDs are commercially avalailable for different wavelengths, and are hence especially suitable for combining both power and colour modulation. Hence the inventive concept may be extended to varying for example R,G,B light sources of a colour display independently. In this way both the power and the colour of the light is varied. Although this does not (or hardly) increase the size of the colour triangle, it does result in a shift of the colour triangle. This shift can be set independently for every segment that is addressed. Although within one segment only a ‘normal’ colour triangle is available, the colour range for the entire screen increases.

In combination with time-sequentially adaptation of the colour gamut also additional enhancements are possible. For instance when an image is analysed to need locally a higher brightness whereas at the remaining area the colour gamut is more important, an extra boost to the brightness can be provided by filling the colour filter bandwidth by simultaneously switching-on all the light sources emitting in this colour region. In yet another embodiment, the modulated outcoupling of light of the scanning backlight operates on the principle of electrically addressed refractive indices that discriminate between total reflection (no outcoupling) and transmission at an interface. The refractive index modulation can be made directionally dependent This means by stacking two index switching layers the first layer will modulate R,G,B coming from one direction whereas the second layer will modulate the slightly shifted R′, G′, B′ colours coming from the orthogonal direction (see fig 13). This has the advantage that both sets of light sources, R,G,B and R′,G′,B′, may be switched on continuously. This might be beneficial if two sets of fluorescent lamps are used rather that the fast switching LEDs. It should also be possible to make the scattering elements directionally dependent.

The protective scope of the invention is not limited to the embodiments shown. The invention resides in each and every novel characteristic and each and every combination of characteristic features. Moreover, reference numerals in the claims are not to be construed as limiting their protective scope.

It shall be noted that the above-described inventive concept may be used for different types of electro-optically active display panels, such as liquid crystal display panels, or other types of light valve or shutter systems. Moreover, it shall be noted that the invention is not limited to monochrome and RGB displays but may in fact be utilised to any display, independent of its colours.

Also, it shall be noted that as described above, the addressable light out-coupling member may comprise an addressable liquid crystal gel layer. However, it is also possible to use a micro-electro-mechanical out-coupling structure as an addressable light out-coupling member and achieve the corresponding effect, and this embodiment is also to be included in the protective scope of the appended claims. Such an addressable light out-coupling member may be realised by means of so called MEMS (micro-electro-mechanical system) technology.

1. A scanning backlight device, based on dynamic light extraction, the device comprising:
a light guide structure,
a light source for emitting light, arranged to be directed into said light guide structure,
the light guide structure being provided with an addressable out-coupling member, comprising two or more defined areas, each providing switchable outcoupling of light from said light guide structure,
characterised in that
at least one micro-optical redirection member, arranged in proximity with said light guide structure, being arranged to redirect light emitted from said light guide structure in an essentially normal direction of said light guide structure.

2. A backlight device as in claim 1, wherein said micro-optical redirection member is arranged as a layer arranged on a forward side of the light guide structure, one surface of the layer being provided with a transmissive prismatic structure.

3. A backlight device as in claim 2, wherein the prismatic structure is arranged on the side of the micro-optical redirection member facing the light guide structure.

4. A backlight device as in claim 2, wherein the top angle of the prismatic structure essentially falls within the interval 40-80°, preferably within 50-70° and most preferably is about 60°.

5. A backlight device as claim 1, wherein the prismatic structure (comprises alternating prismatic protrusions and flat areas.

6. A backlight device as in claim 1, wherein said micro-optical redirection member is arranged as a layer arranged on a rearward side of the light guide structure, one surface of the layer being provided with a reflective prismatic structure.

7. A backlight device as in claim 6, wherein the prismatic structure is arranged on the side of the micro-optical redirection member facing the light guide structure.

8. A backlight device as in claim 6, wherein the top angle of the prismatic structure essentially falls within the interval 70-110°, preferably within 80-100° and most preferably is about 90°.

9. A backlight device according to claim 1, wherein the addressable out-coupling member is provided with one of an addressable liquid crystal gel layer or a micro-electro-mechanical out-coupling structure.

10. A backlight device according to claim 1, further comprising a light source modulator for modulating the power of the light source of the backlight device, said modulation being dependent on an illumination pattern to be displayed by said backlight device.

11. A display device, comprising a scanning backlight as described in claim 1.
